(19) United States
(12) Patent Application Publication
(10) Pub. No.: US 2024/0005131 A1
(43) Pub. Date: Jan. 4, 2024

(54) ATTENTION NEURAL NETWORKS WITH TREE ATTENTION MECHANISMS

(71) Applicant: Google LLC, Mountain View, CA (US)

(72) Inventors: Himanshu Jain, Jersey City, NJ (US); Lovish Madaan, Bengaluru (IN); Prateek Jain, Bangalore (IN); Venkata Sesha Pavana Srinadh Bhojanapalli, New York, NY (US)

(21) Appl. No.: 18/343,723

(22) Filed: Jun. 28, 2023

(30) Foreign Application Priority Data
Jun. 28, 2022 (IN) 202221037019

(51) Int. Cl. G06N 3/0455

(52) U.S. Cl. CPC G06N 3/0455

(57) ABSTRACT

Systems and methods for processing inputs using attention neural networks with tree attention layers. Each tree attention layer includes one or more tree attention sub-layers that are each configured to: process query vectors using a decision tree model for the tree attention sub-layer to determine a respective tree path for each query vector; process key vectors using the decision tree model to determine a respective tree path for each key vector; and generate an attended input sequence comprising a respective attended input at each of the plurality of input positions, comprising: generating, for each particular input position, the respective attended input at the particular input position based on (i) the tree path for the query vector at the particular input position (ii) the respective tree paths for the key vectors at each of the plurality of input positions and (iii) the value vectors at a subset of the input positions.

### CROSS-REFERENCE TO RELATED APPLICATION

This application claims the benefit under 35 U.S.C. § 119(a) of the filing date of Indian Patent Application No. 202221037019, filed in the Indian Patent Office on Jun. 28, 2022. The disclosure of the foregoing application is herein incorporated by reference in its entirety.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that performs a machine learning task on a network input.

The machine learning task can be any machine learning task that (i) operates on a network input that is an input sequence, (ii) generates a network output that is an output sequence, or (iii) both.

In particular, the system performs the task using an attention neural network that includes one or more tree attention layers.

A tree attention layer is an attention layer that includes one or more tree attention sub-layers that use a decision tree model for the tree attention sub-layer to compute attended input sequences.

Particular embodiments of the subject matter described in this specification can be implemented so as to realize one or more of the following advantages.

The techniques described in this specification allow a neural network system to process input sequences, generate output sequences, or both more efficiently than existing attention-based networks both during training and at run-time, i.e., in terms of computational resources (e.g., memory, computing power, or both), by making use of a tree attention mechanism.

The attention layers within some existing attention neural networks employ a dot-product attention mechanism which involves computing, for every given query vector, respective dot products of the query vector with all of the key vectors. The networks typically derive such key vectors or query vector vectors from network inputs that may be sequential. Thus the computational cost could be substantial when applying a dot-product attention mechanism over sequential data that is of significant length. In particular, conventional self-attention layers have a quadratic dependency on the sequence length, resulting in the model consuming a large amount of computational resources when operating on or generating longer sequences. The described techniques, however, address these problems by using decision trees within the attention layers to employ decision tree based hierarchical navigation to reduce the retrieval cost per query token from linear in sequence length to nearly logarithmic.

Thus, the resulting neural network can achieve comparable results to conventional Transformer-based architectures while being significantly more computationally efficient and having much lower latency. As a particular example, the described systems can achieve comparable accuracy to a baseline Transformer while using 30× lesser FLOPs in the attention layer. Compared to other “sparse” attention variants, the accuracy can be significantly higher, e.g., as much as 12% higher in some cases, while using similar FLOPs in the attention layer.

This specification also describes techniques for overcoming the training challenges that come with incorporating decision trees into a large model. For example, the specification describes a two-level bootstrapped training method that allows the system to iteratively incorporate tree attention layers into the neural network during training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example architecture of a tree attention layer.

FIG. 3 is a flow diagram of an example process for processing an input using a tree attention layer.

FIG. 4 is a flow diagram of an example process for training an attention neural network that includes tree attention layers.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task.

The machine learning task can be any machine learning task that (i) operates on a network input that is an input sequence, (ii) generates a network output that is an output sequence, or (iii) both.

Some examples of machine learning tasks that the system can be configured to perform follow.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input, e.g., text, a lower-resolution image, or a partial image, and the output is a sequence of intensity value inputs for the pixels of an image.

As another example, the task can be an image processing task. For example, the input can be the intensity values of the pixels of the image or an encoded representation of the intensity values of the pixels generated by an encoder neural network, and the network output can be (i) an image classification output that classifies the input image into one of a plurality of object categories (ii) an object detection output, i.e., a sequence that specifies the coordinates of one or more bounding boxes in the image that are predicted to encompass objects or (iii) a segmentation output that classifies each pixel in the input image into one of a plurality of categories. As another example, the input can include the intensity values of the pixels of the image or an encoded representation of the intensity values of the pixels generated by an encoder neural network and optionally text, and the network output can be text that characterizes the image, e.g., captions the image or answers a question posed by the text in the input about the image.

As another example, the task can be an audio generation task, where the input is a conditioning input, e.g., text, an image, or context audio, and the output is a sequence of tokens that represents audio.

As another example, the task can be an audio processing task. For example, the input include audio or an encoded representation of the audio generated by an encoder neural network, and the network output can be text or an image that characterizes the audio.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

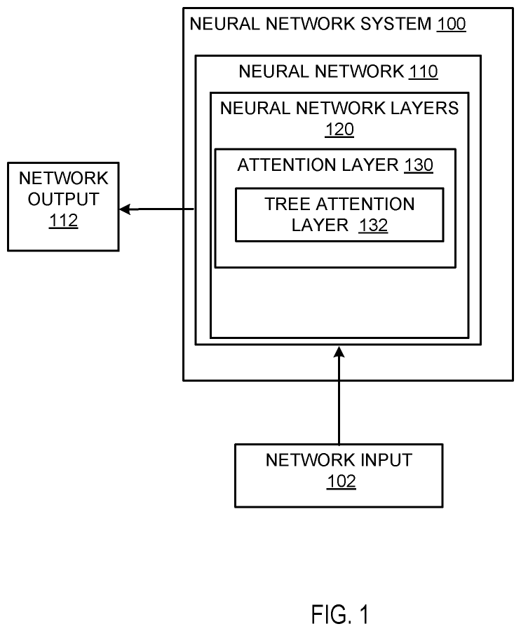

FIG. 1 shows an example neural network system 100. The neural network system 100 is an example of a system implemented as computer programs on one or more computers in one or more locations, in which the systems, components, and techniques described below can be implemented.

The system 100 is a system that processes a network input 102 using an attention neural network 110 to generate a network output 112 for a machine learning task, e.g., one of the tasks described above.

Generally, the neural network layers 120 within the attention neural network 110 include one or more initial neural network layers, e.g., an embedding layer and optionally one or more additional layers, a sequence of attention layers 130, and one or more output layers that process the output of the last attention layer 130 in the sequence as part of generating the network output 112.

As one example, when the network input 102 is an input sequence, the attention neural network 110 can process the network input 102 in a single forward pass to generate the network output 112.

As another example, when the network input 102 is an input sequence or has been mapped to an input sequence by an encoder neural network and the network output 112 is also a sequence that includes multiple elements, the attention neural network 110 can operate auto-regressively and generate the network output 112 over multiple time steps. At each time step, the attention neural network 110 processes the network input 102 (or a sequence generated from the network input 102) and the already generated elements of the output sequence to generate the next one or more elements of the output sequence.

As yet another example, when the network input 102 is an input sequence and the network output 112 is also a sequence that includes multiple elements, the attention neural network 110 can include an encoder neural network that generates a respective encoded representation of each of the inputs in the input sequence in a single forward pass and a decoder neural network that operates auto-regressively and generates the network output 112 over multiple time steps. At each time step, the decoder neural network processes the encoded representations and the already generated elements of the output sequence to generate the next one or more elements of the output sequence. In these examples, some of the attention layers 130 are in the encoder neural network while others are in the decoder neural network.

Each attention layer 130 operates on a respective input sequence that includes a respective input vector at each of one or more positions.

Moreover, each of the layers 130 includes an attention mechanism layer and, in some implementations, a feed-forward layer.

The attention mechanism layer receives the input sequence for the layer and applies an attention mechanism on the input sequence for the layer to generate an attended input sequence.

The attention mechanism applied by the attention mechanism layer depends on the configuration of the attention neural network.

As one example, as described above, when the network input 102 is an input sequence, the attention neural network 110 can process the network input 102 in a single forward pass to generate the network output 112. In this example, the attention mechanism layers apply non-causal self-attention.

As another example, as described above, when the network input 102 is an input sequence or has been mapped to an input sequence by an encoder neural network and the network output 112 is also a sequence that includes multiple elements, the attention neural network 110 can operate auto-regressively and generate the network output 112 over multiple time steps. At each time step, the attention neural network 110 processes the network input 102 (or the sequence generated from the network input) and the already generated elements of the output sequence to generate the next one or more elements of the output sequence. In this example, the attention mechanism apply causal self-attention.

As another example, when the network input 102 is an input sequence and some of the attention layers are in the encoder portion of the attention neural network 110 and other layers are in the decoder portion of the attention neural network 110, the attention neural network 110 can process the network input 102 using the encoder portion in a single forward pass to generate an encoded representation of the input. In this example, the attention mechanism layers within the encoder portion apply non-causal self-attention. The decoder portion of the attention neural network 110 can then operate auto-regressively and generate the network output 112 over multiple time steps. At each time step, the attention neural network 110 processes the already generated elements of the output sequence to generate the next one or more elements of the output sequence conditioned on the encoded representation. In this example, some of the attention mechanism layers in the decoder apply causal self-attention while others of the attention mechanism layers in the decoder apply cross-attention between the already generated elements of the output sequence and the encoded representation.

Generally, however, some or all of the attention mechanism layers are tree attention layers 132.

Each tree attention layer 132 includes one or more tree attention sub-layers. That is, when the layer 132 includes multiple tree attention sub-layers, the layer 132 operates as a multi-head attention layer and, when the layer 132 includes a single tree attention sub-layer, the layer 132 operates as a single-head attention layer.

Each tree attention sub-layer uses a decision tree model for the tree attention sub-layer to compute attended input sequences.

The decision tree model for each attention sub-layer has multiple levels of nodes, with each level having one or more nodes.

In particular, the decision tree model has a sequence of h levels and each level l has a respective set of nodes. Each node in each level other than the last level of the decision tree model has multiple child nodes in the following layer. The nodes in the last level that have no child nodes are called the “leaf nodes.”

For example, when the decision tree model is a binary tree, each node in level l has 2^{l-1} nodes, i.e., so that each node in any given level other than the last level has two child nodes in the next level.

More generally, the decision tree model can be an n-ary tree, where different nodes in different levels can have different numbers of nodes. For example, in a three level tree, the root node in level 0 of the tree can have 100 child nodes, resulting in 100 nodes in level 1. Each node in level 1 can have ten child nodes, resulting in 1000 total leaf nodes in level 2.

At each node in each level other than the last level, the decision tree model uses a learned classifier for the node to determine which of the child nodes of the node a given input that has been routed to the node should be routed to.

Thus, the model routes each input vector along a path (“tree path”) that includes a respective node at each level of the model. That is, the tree path for a given input vector identifies the node traversed by the given input vector in each of the levels.

Unlike conventional attention layers, the tree attention layer 132 uses these tree paths to determine the output of the attention mechanism applied by the tree attention layer 132.

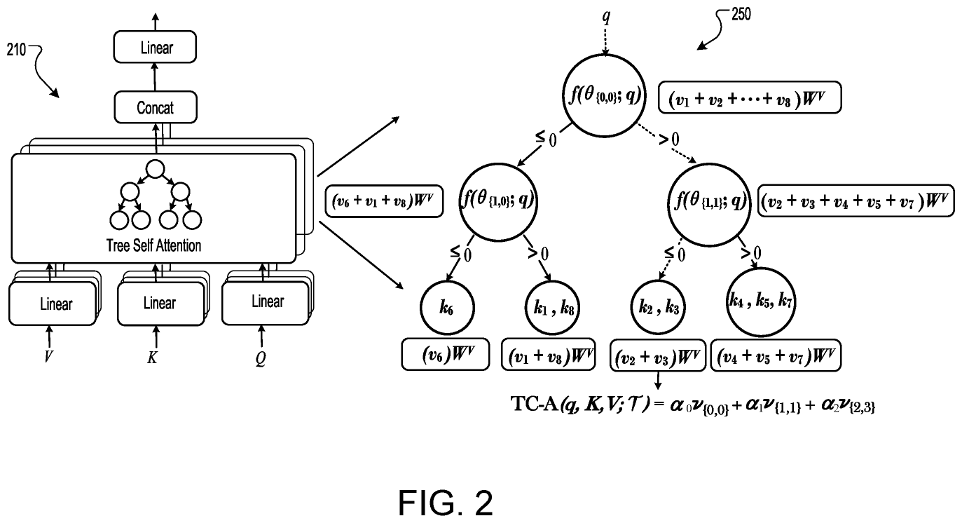

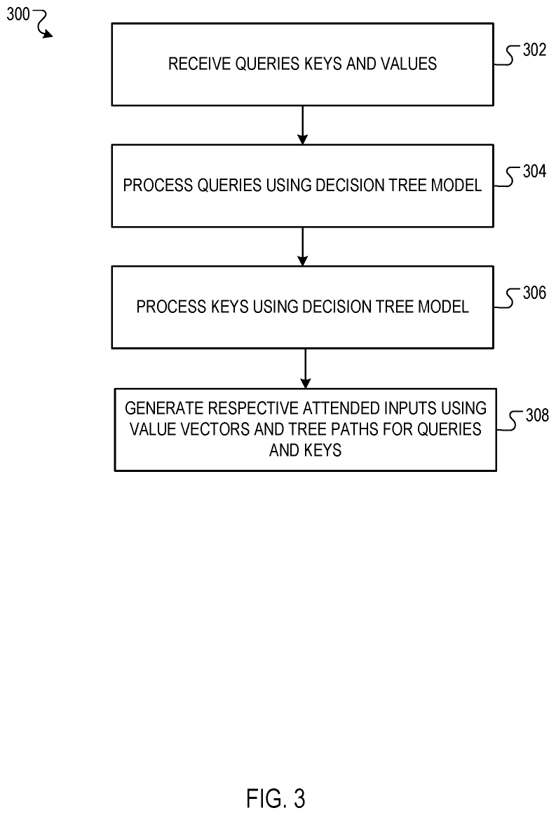

Using a decision tree model to generate an attended input sequence is described in more detail below with reference to FIGS. 2 and 3.

When there are multiple tree attention sub-layers within the tree attention layer 132, the tree attention layer 132 then generates a final attended input sequence from the attended input sequences generated by the sub-layers.

In some cases, the final attended input sequence generated by the tree attention layer 132 is the output sequence for the attention mechanism layer, while in other cases the layer applies one or more transformations, e.g., residual connections, normalization operations, or both, to the final attended input sequence to generate the output sequence for the attention mechanism layer.

In some cases, the output sequence generated by the attention mechanism layer is the output sequence for the attention layer 130.

In some other cases, each attention layer 130 also includes one or more feed-forward sub-layers. When included, the one or more feed-forward sub-layer(s) then operate on the output sequence generated by the attention mechanism layer to generate an output sequence for the layer by applying a series of operations on each attended input of the final attended input sequence in parallel, e.g., by processing each attended input through a fully-connected neural network and then, optionally, applying layer normalization, a residual connection, or both to the output of the fully-connected neural network. As a particular example, the fully-connected neural network can apply, to each attended input in parallel, one linear transformation, followed by an activation function, e.g., a non-linear elementwise activation function, e.g., a ReLU activation function, and then followed by another linear transformation.

As used in this specification, the term “learned” means that an operation or a value has been adjusted during the training of the attention neural network.

FIG. 2 is an illustration 200 of a tree attention mechanism being applied to an input sequence. As described above, the tree attention mechanism can be applied by one of multiple attention heads (sub-layers) 210 of tree attention layer 132 or by a tree attention layer 132 that has a single attention head 210.

For the sake of clarity, the tree attention mechanism will be described as being performed by an attention sub-layer 210, which can correspond to either the single attention head of a tree attention layer or to one of multiple attention heads of the tree attention layer.

To apply the attention mechanism, the attention sub-layer 210 obtains (i) a sequence of queries derived from the input sequence to the attention mechanism layer, (ii) a sequence of keys, and (iii) a sequence of values.

When the attention mechanism being applied by the tree attention layer is self-attention, the sequence of keys and the sequence of values are also derived from the input sequence to the attention mechanism layer. That is, the matrices Q, K, and V in FIG. 2 all correspond to a matrix of inputs in the input sequence.

For example, the sub-layer 210 can generate the queries, keys, and values by applying different, learned linear transformations to the input sequence.

In other words, the sub-layer 210 can apply a respective query linear transformation to the input sequence to generate the sequence of queries for the sub-layer, apply a respective key linear transformation to the input sequence to generate the sequence of keys for the tree attention sub-layer, and apply a value linear transformation to the input sequence to generate the sequence of value inputs for the tree attention sub-layer. Each linear transformation can include multiplying each input in the sequence by a corresponding learned weight matrix and, optionally, adding a corresponding learned bias.

When the attention mechanism being applied by the tree attention layer is cross-attention between (i) the input sequence to the attention mechanism layer and (ii) a sequence of encoded representations, the sequence of keys and the sequence of values are derived from the sequence of encoded representations. That is, the matrix Q in FIG. 2 corresponds to a matrix of inputs in the input sequence while the matrices Q and K correspond to a matrix of encoded representations in the sequence of encoded representations.

In this example, the sub-layer 210 can apply a respective query linear transformation to the input sequence to generate the sequence of queries for the sub-layer, apply a respective key linear transformation to sequence of encoded representations to generate the sequence of keys for the tree attention sub-layer, and apply a value linear transformation to the sequence of encoded representations to generate the sequence of value inputs for the tree attention sub-layer. Each linear transformation can include multiplying each input in the sequence by a corresponding learned weight matrix and, optionally, adding a corresponding learned bias.

The sub-layer 210 then generates an attended input sequence that includes a respective attended input at each of the plurality of input positions by applying a tree attention mechanism that uses a decision tree model 250.

As shown in FIG. 2, when there are multiple sub-layers 210, the tree attention layer 132 then combines the attended input sequences generated by the multiple sub-layers 210 by concatenating (“concat”) the attended input sequences to generate a sequence of concatenated attended inputs and then applying a linear transformation to each concatenated attended input to generate the final attended input sequence.

As shown in the example of FIG. 2, the decision tree model 250 for the sub-layer 210 includes three levels, with level 0 having a single node that has two child nodes, level 1 having the two child nodes of the root node at level 0, and level 2 having two child nodes for each of the nodes in level 1, i.e., four total nodes. Thus, the decision tree model 250 includes four leaf nodes.

At each node in each level other than the last level, the decision tree model 250 uses a learned classifier f to determine which of the two child nodes of the node a given input that has been routed to the node should be routed to. The classifier f for each of the nodes has respective parameters θ, i.e., so that after training different classifiers for different nodes can have different parameter values. For example, the parameters of each classifier f can include a bias value and a weight vector and the classifier can compute the output of the classifier by computing a dot product between the weight vector and the input and then adding the bias value.

In the example of FIG. 2, for each node, the decision tree model 250 processes the given input using the classifier f for the node and then determines to route the given input based on the sign of the output of the classifier, e.g., routing the given input to the left child node when the output is less than or equal to zero and routing the given input to the right child node when the output is greater than zero.

To apply the tree attention mechanism, the sub-layer 210 processes each query vector using a decision tree model 250 for the tree attention sub-layer to determine a respective tree path for each query vector. As described above, the respective tree path for each query vector identifies, for each level of nodes, the node from the level that was traversed by the query vector. As shown in the example of FIG. 2, the tree path for a query q includes the root node {0,0} level 0, child node {1, 1} at level 1, and leaf node {2, 3} at level 2.

The sub-layer 210 also processes each key vector using the decision tree model 250 to determine a respective tree path for each key vector, the respective tree path for each key vector identifying, for each level of nodes, a node from the level that was traversed by the key vector.

As shown in the example of FIG. 2, there are 8 key vectors that correspond to input positions 1-8 of the input sequence and that have been routed to respective leaf nodes by the decision tree models.

The sub-layer 210 then generates the attended input sequence by generating, for each particular input position, the respective attended input at the particular input position based on (i) the tree path for the query vector at the particular input position (ii) the respective tree paths for the key vectors at each of the plurality of input positions and (iii) the value vectors at a subset of the input positions.

The sub-layer 210 can apply any of a variety of tree attention mechanisms that make use of the decision tree model 250 and the way the sub-layer 210 generates the attended input at the particular input positions from (i), (ii), and (iii) depends on the tree attention mechanism that is being employed.

One example of a tree attention mechanism is a Tree Fine-Grained Attention (TF-ATTENTION) mechanism.

In TF-ATTENTION, the sub-layer 210 computes the attended input for the particular position as a weighted sum of value vectors of keys that were routed to the same leaf node as the query at the particular position.

That is, for each particular input position, the sub-layer 210 determines a respective subset of input positions that includes only input positions for which the key vector traversed the same leaf node in the decision tree model as the query vector for the particular input position (and not any input positions for which the key vector traversed a different leaf node in the decision tree model as the query vector for the particular input position). In the example of FIG. 2, the respective subset for query q would include only positions 2 and 3, since the keys for those positions were the only keys routed to the same leaf node as the query q.

The sub-layer 210 then determines a respective attention weight for each input position in the respective subset and combines the respective value vectors for the input positions in the respective subset selected for the particular input position in accordance with the attention weights.

To determine the respective attention weights for each of the input positions in the respective selected for the particular input position, the sub-layer 210 can use the query vector for the particular input position and the key vectors for the input positions in the respective subset selected for the particular input position.

softmax

$$( \frac{{{q}^{T} ( {K}_{\overline{S}} )}^{T}}{\sqrt{d}} ) {V}_{\overline{S}} \overline{S} {K}_{\overline{S}} {V}_{\overline{S}} A s$$

one example, the attended input for a particular input position can be computed as follows:

softmax

$$( \frac{{{q}^{T} ( {K}_{\overline{S}} )}^{T}}{\sqrt{d}} ) {V}_{\overline{S}} \overline{S} {K}_{\overline{S}} {V}_{\overline{S}} ,$$

softmax

$$( \frac{{{q}^{T} ( {K}_{\overline{S}} )}^{T}}{\sqrt{d}} ) {V}_{\overline{S}} \overline{S} {K}_{\overline{S}} {V}_{\overline{S}}$$

where q is the query for the particular input position and is the subset of input positions for the input positions, d is the dimensionality of the query key and value vectors, is a matrix of the key vectors for the subset of input positions, and is a matrix of the value vectors for the subset of input positions.

Another example of a tree attention mechanism is a Tree Coarse Attention (TC-ATTENTION) mechanism.

In TC-ATTENTION, rather than computing attention as a weighted sum of values of keys in the leaf node, the sub-layer 210 computes a coarse unweighted sum of the value vectors. That is, the query is only used to navigate to a leaf node, but with-in a leaf node, the value vector is fixed. So given a leaf node, the attention value is independent of the query itself.

That is, for each particular input position and for one or more of the nodes identified in the respective tree path for the query vector at the particular input position, the sub-layer 210 generates a respective node value vector for the node from value vectors at input positions for which the key vector traversed the node.

In particular, for a given node that is in the tree path for a given query vector, the sub-layer 210 identifies the key vectors that traversed the node, i.e., the key vectors for which the node is included in the tree path for the key vector.

$$\frac{1}{\vert {S}_{l , j} ( K ) \vert} {Σ}_{i ∈ {S}_{l , j} ( K )} {V}_{i} {S}_{l , j} ( K )$$

The sub-layer 210 then determines a node value vector for the node from the value vectors at the same input positions as the key vectors that traversed the node (and not from the value vectors at any input positions that are not the input position for any of the key vectors that traversed the node). For example, the sub-layer 210 can compute the respective node value vector by averaging the value vectors at input positions for which the key vector traversed the node. Thus, in this example the node value vector for node j at level l can satisfy:

$$\frac{1}{\vert {S}_{l , j} ( K ) \vert} {Σ}_{i ∈ {S}_{l , j} ( K )} {V}_{i} {S}_{l , j} ( K ) ,$$

$$\frac{1}{\vert {S}_{l , j} ( K ) \vert} {Σ}_{i ∈ {S}_{l , j} ( K )} {V}_{i} {S}_{l , j} ( K )$$

where is the set of input positions for which the key vector has traversed the node j at level l.

For each particular input position, the sub-layer 210 then combines the respective node value vectors for the one or more nodes identified in the respective tree path for the query vector for the input position to generate the attended input at the input position.

As a particular example, the sub-layer 210 can combine the respective node value vectors by determining a weighted sum of the respective node value vectors for the one or more nodes identified in the respective tree path for the query vector, where the node value vector for each node is weighted by a weight for a level to which the node belongs.

In some implementations, rather than being pre-determined or determined using a hyperparameter sweep, the weights for the layer can be learned during the training of the neural network.

In some other implementations, the weights can depend on the query vector for the particular input position. For example, the sub-layer 210 can learn, during the training of the neural network, a linear mapping from the query vector to respective weights for each of one or more of the levels in the decision tree model.

In some implementations, the one or more nodes identified in the respective tree path that are used to compute the attended input can include only the leaf node in the respective tree path.

In some other implementations, the one or more nodes identified in the respective tree path that are used to compute the attended input includes the leaf node in the respective tree path and one or more other nodes in the respective tree path.

|S_{l,j}(K)|Σₗαₗv_{{l,p}_{ₗ}_{}} For example, in the example of FIG. 2, all of the nodes in the respective tree path are used to compute the attended input and the example shows the computation of a respective node vector for all of the nodes in the decision tree model 250 (omitting the division by). The example also shows that the attended input for the input position of the query q is equal to a weighted sum of the node value vectors for the node {0,]0}, the node {1,1}, and the node {2,3}. More generally, the attended input for a particular input position can satisfy:

|S_{l,j}(K)|Σₗαₗv_{{l,p}_{ₗ}_{}}

where l ranges over the levels of the decision tree that are used to compute attended input, αₗ is the weight for the layer l, and v_{{l,p}_{ₗ}_{}} is the node value vector for the node pₗ at level l that is in the tree path for the query at the particular input position.

FIG. 3 is a flow diagram of an example process 300 for applying a tree attention mechanism. For convenience, the process 300 will be described as being performed by a system of one or more computers located in one or more locations. For example, a neural network system, e.g., neural network system 100 of FIG. 1, appropriately programmed in accordance with this specification, can perform the process 300.

The process 300 can be performed by each sub-layer of a tree attention layer to generate a respective attended input sequence for the sub-layer.

The system receives (i) a sequence of queries derived from an input sequence to the sparse attention layer, the sequence of queries having a respective query at each of a plurality of input positions; (ii) a sequence of keys derived from the input sequence to the sparse attention layer, the sequence of keys having a respective key at each of the plurality of input positions; and (iii) a sequence of value inputs derived from the input sequence to the sparse attention layer, the sequence of value inputs having a respective value input at each of the plurality of input positions (step 302).

The system processes each query vector using a decision tree model for the tree attention sub-layer to determine a respective tree path for each query vector (step 304). As described above, the decision tree model has a plurality of levels of nodes and the respective tree path for each query vector identifies, for each level of nodes, a node from the level that was traversed by the query vector.

The system processes each key vector using the decision tree model to determine a respective tree path for each key vector, the respective tree path for each key vector identifying, for each level of nodes, a node from the level that was traversed by the key vector (step 306).

The system then generates an attended input sequence that has a respective attended input at each of the plurality of input positions.

In particular, the system generates, for each particular input position, the respective attended input at the particular input position based on (i) the tree path for the query vector at the particular input position (ii) the respective tree paths for the key vectors at each of the plurality of input positions and (iii) the value vectors at a subset of the input positions (step 308). For example, the system can use an appropriate variant of tree attention to determine the respective attended inputs. As particular examples, the system can use the TF-ATTENTION or TC-ATTENTION variants described above with reference to FIG. 2.

During the processing of a given network input, for each tree attention layer in the attention neural network, the system can perform the process 300 to update the input sequence to the layer. By repeatedly performing this processing for all of the attention layers in the attention neural network and then by processing at least part of the output sequence generated by the last attention layer in the attention neural network using one or more output layers, e.g., one or more linear layers optionally followed by a softmax layer or, more generally, a multi-layer perceptron (MLP), the system can generate a network output for a received network input.

That is, the process 300 can be performed as part of predicting an output for an input for which the desired output, i.e., the output that should be generated by the system for the input sequence, is not known.

The process 300 can also be performed as part of processing inputs derived from a set of training data, i.e., inputs derived from a set of inputs for which the output that should be generated by the system is known, in order to train the attention neural network to determine trained values for the parameters of the attention neural network.

The system can repeatedly perform the process 300 on inputs selected from a set of training data as part of a conventional machine learning training technique to train the attention layers and the output layer(s) of the neural network, e.g., a gradient descent with backpropagation training technique that uses a conventional optimizer, e.g., stochastic gradient descent, RMSprop, or Adam optimizer, to optimize an objective function that is appropriate for the task that the attention neural network is configured to perform.

During training, the system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the attention neural network in parallel.

Moreover, the system can first pre-train the neural network on a large unsupervised data set through unsupervised learning, e.g., to minimize a BERT loss or other unsupervised loss, and then fine-tune the neural network on task-specific training data to optimize the objective function for the task.

In some cases, incorporating decision trees into a large model can create training challenges. For example, the discrete structure of a decision tree can hamper gradient flow through the model during training. In some cases, to account for this, the system can train the model using the techniques described in Ajaykrishna Karthikeyan, Naman Jain, Nagarajan Natarajan, and Prateek Jain. Learning accurate decision trees with bandit feedback via quantized gradient descent. arXiv preprint arXiv:2102.07567, to alleviate some of these challenges and ensure better flow of gradients through the network.

However, in some cases, even incorporating these training techniques can result in poor performance, especially when pre-training the neural network on a large data set.

In some cases, to overcome these issues, the system can pre-train the neural network using a two-level bootstrapped training method that allows the system to iteratively incorporate tree attention layers into the neural network during training.

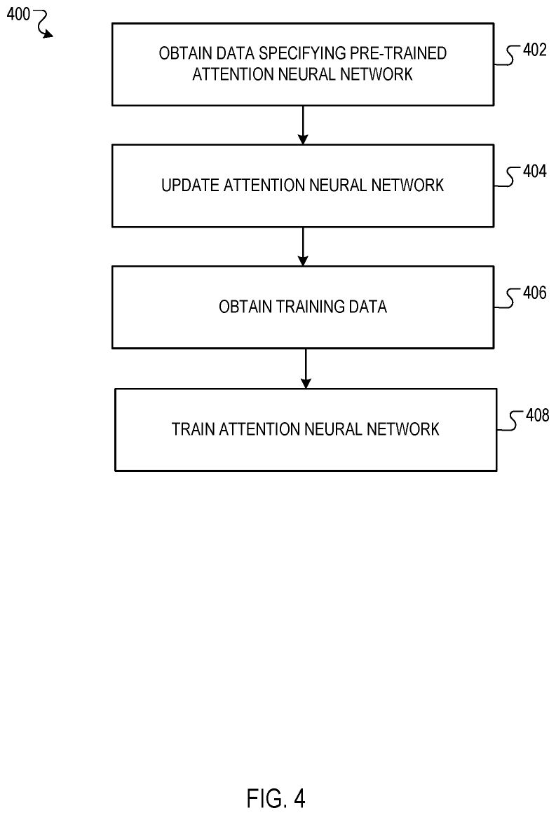

FIG. 4 is a flow diagram of an example process 400 for training an attention neural network by iteratively adding tree attention layers. For convenience, the process 400 will be described as being performed by a system of one or more computers located in one or more locations. For example, a neural network system, e.g., neural network system 100 of FIG. 1, appropriately programmed in accordance with this specification, can perform the process 400.

The system obtains data specifying an initial, pre-trained attention neural network that includes a plurality of original attention layers (step 402). For example, the initial attention neural network can have been pre-trained as described above and can have conventional attention layers in place of tree attention layers, but can otherwise have the same architecture as the attention neural network.

The system then further trains the neural network at multiple training stages.

At each of the plurality of training stages, the system updates the attention neural network by replacing one or more of the original attention layers in the attention neural network as of the training stage with a corresponding new tree attention layer (step 404). For example, the system can replace one or more highest original attention layers in the sequence with a corresponding new tree attention layer. In particular the system can replace a fixed number, e.g., 1, 2, or 3, highest original attention layers in the sequence with a new tree attention layer.

The system obtains training data for the training stage (step 406). For example, the training data can include some or all of the training data used to pre-train the original neural network.

The system trains the attention neural network on the training data by training the one or more corresponding new tree attention layers while holding any original attention layers in the attention neural network fixed (step 408), e.g., using a self-supervised learning objective as described above.

The system can perform training stages until all of the layers or some predetermined subset of original attention layers have been replaced with (trained) tree attention layers.

The system can also perform a similar bootstrapping procedure to increase the tree height of the decision trees within the tree attention layers of an already-trained attention neural network that has tree attention layers.

An “embedding,” as used in this specification is a vector of numeric values, e.g., floating point or other type of numeric values, that has a predetermined dimensionality, e.g., has a predetermined number of values.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system for performing a machine learning task on a network input to generate a network output, the system comprising one or more computers and one or more storage devices storing instructions that, when executed by the one or more computers, cause the one or more computers to implement:
an attention neural network configured to perform the machine learning task, the attention neural network comprising one or more tree attention layers, each tree attention layer comprising one or more tree attention sub-layers, each tree attention sub-layer configured to:
receive a sequence of query vectors derived from an input sequence to the tree attention layer, the sequence of query vectors having a respective query vector at each of a plurality of input positions;
receive a sequence of key vectors derived from the input sequence to the tree attention layer, the sequence of key vectors having a respective key vector at each of the plurality of input positions;
receive a sequence of value vectors derived from the input sequence to the tree attention layer, the sequence of value vectors having a respective value vector at each of the plurality of input positions;
process each query vector using a decision tree model for the tree attention sub-layer to determine a respective tree path for each query vector, the decision tree model having a plurality of levels of nodes and the respective tree path for each query vector identifying, for each level of nodes, a node from the level that was traversed by the query vector;
process each key vector using the decision tree model to determine a respective tree path for each key vector, the respective tree path for each key vector identifying, for each level of nodes, a node from the level that was traversed by the key vector; and
generate an attended input sequence comprising a respective attended input at each of the plurality of input positions, comprising:
generating, for each particular input position, the respective attended input at the particular input position based on (i) the tree path for the query vector at the particular input position (ii) the respective tree paths for the key vectors at each of the plurality of input positions and (iii) the value vectors at a subset of the input positions.

2. The system of claim 1, wherein generating, for each particular input position, the respective attended input at the particular input position based on (i) the tree path for the query vector at the particular input position (ii) the respective tree paths for the key vectors at each of the plurality of input positions and (iii) the value vectors at a subset of the input positions comprises:
selecting, for each particular input position, a respective subset of input positions that includes only input positions for which the key vector traversed a same leaf node in the decision tree model as the query vector for the particular input position.

3. The system of claim 2, wherein generating, for each particular input position, the respective attended input the position based on (i) the tree path for the query vector at the particular input position (ii) the respective tree paths for the key vectors at each of the plurality of input positions and (iii) the value vectors at a subset of the input positions comprises:
determining, for each particular input position, a respective attention weight for each input position in the respective subset selected for the particular input position based on the query vector for the particular input position and the key vectors for the input positions in the respective subset selected for the particular input position; and
combining the respective value vectors for the input positions in the respective subset selected for the particular input position in accordance with the attention weights.

4. The system of claim 1, wherein generating, for each particular input position, the respective attended input at the particular input position based on (i) the tree path for the query vector at the particular input position (ii) the respective tree paths for the key vectors at each of the plurality of input positions and (iii) the value vectors at a subset of the input positions comprises:
for each particular input position and for one or more of the nodes identified in the respective tree path for the query vector at the particular input position, generating a respective node value vector for the node from value vectors at input positions for which the key vector traversed the node; and
combining the respective node value vectors for the one or more nodes identified in the respective tree path for the query vector.

5. The system of claim 4, wherein generating a respective node value vector for the node from value vectors at input positions for which the key vector traversed the node comprises:
averaging the value vectors at input positions for which the key vector traversed the node.

6. The system of claim 4, wherein the one or more nodes identified in the respective tree path includes only a leaf node in the respective tree path.

7. The system of claim 4, wherein the one or more nodes identified in the respective tree path includes a leaf node in the respective tree path and one or more other nodes in the respective tree path.

8. The system of claim 4, wherein combining the respective node value vectors for the one or more nodes identified in the respective tree path for the query vector comprises:
determining a weighted sum of the respective node value vectors for the one or more nodes identified in the respective tree path for the query vector, wherein the node value vector for each node is weighted by a weight for a level to which the node belongs.

9. The system of claim 8, wherein the weights are learned during the training of the neural network.

10. The system of claim 8, wherein the weights depend on the query vector for the particular input position.

11. The system of claim 1, wherein each of the one or more tree attention layers applies, for each tree attention sub-layer, a respective query vector linear transformation to the input sequence to generate the sequence of query vector vectors for the sub-layer.

12. The system of claim 1, wherein each of the one or more tree attention layers applies, for each tree attention sub-layer, a respective key vector linear transformation to the input sequence to generate the sequence of key vectors for the tree attention sub-layer.

13. The system of claim 1, wherein each of the one or more tree attention layers applies, for each tree attention sub-layer, a respective value linear transformation to the input sequence to generate the sequence of value inputs for the tree attention sub-layer.

14. The system of claim 1, wherein each tree attention layer is further configured to:
generate a final attended input sequence from the attended input sequences generated by the one or more sub-layers.

15. The system of claim 14, wherein each tree attention layer further comprises:
one or more position-wise feed-forward layers that are configured to generate an output sequence for the layer from the final attended input sequence, the output sequence comprising a respective layer output at each of the plurality of input positions, and the generating comprising, for each of the plurality of input positions:
receiving an attended layer input at the input position, and
applying a sequence of transformations to the attended layer input at the input position to generate a layer output for the input position.

16. A method performed by one or more computers, the method comprising:
obtaining data specifying an initial, pre-trained attention neural network comprising a plurality of original attention layers; and
at each of a plurality of training stages:
updating the attention neural network by replacing one or more of the original attention layers in the attention neural network as of the training stage with a corresponding new tree attention layer;
obtaining training data for the training stage; and
training the attention neural network on the training data, comprising:
training the one or more corresponding new tree attention layers while holding any original attention layers in the attention neural network fixed.

17. The method of claim 16, wherein the plurality of attention layers are arranged in a sequence, and wherein updating the attention neural network comprises:
replacing one or more highest original attention layers in the sequence with a corresponding new tree attention layer.

18. The method of claim 16, wherein training the attention neural network on the training data comprises training the attention neural network on the training data through self-supervised learning.

19. A method performed by one or more computers and for performing a machine learning task on a network input, the method comprising:
receiving the network input; and
processing the network input using an attention neural network configured to perform the machine learning task, the attention neural network comprising one or more tree attention layers, each tree attention layer comprising one or more tree attention sub-layers, each tree attention sub-layer configured to:
receive a sequence of query vectors derived from an input sequence to the tree attention layer, the sequence of query vectors having a respective query vector at each of a plurality of input positions;
receive a sequence of key vectors derived from the input sequence to the tree attention layer, the sequence of key vectors having a respective key vector at each of the plurality of input positions;
receive a sequence of value vectors derived from the input sequence to the tree attention layer, the sequence of value vectors having a respective value vector at each of the plurality of input positions;
process each query vector using a decision tree model for the tree attention sub-layer to determine a respective tree path for each query vector, the decision tree model having a plurality of levels of nodes and the respective tree path for each query vector identifying, for each level of nodes, a node from the level that was traversed by the query vector;
process each key vector using the decision tree model to determine a respective tree path for each key vector, the respective tree path for each key vector identifying, for each level of nodes, a node from the level that was traversed by the key vector; and
generate an attended input sequence comprising a respective attended input at each of the plurality of input positions, comprising:
generating, for each particular input position, the respective attended input at the particular input position based on (i) the tree path for the query vector at the particular input position (ii) the respective tree paths for the key vectors at each of the plurality of input positions and (iii) the value vectors at a subset of the input positions.

20. The method of claim 19, wherein generating, for each particular input position, the respective attended input at the particular input position based on (i) the tree path for the query vector at the particular input position (ii) the respective tree paths for the key vectors at each of the plurality of input positions and (iii) the value vectors at a subset of the input positions comprises:
selecting, for each particular input position, a respective subset of input positions that includes only input positions for which the key vector traversed a same leaf node in the decision tree model as the query vector for the particular input position.
